(19) United States
(12) Patent Application Publication
(10) Pub. No.: US 2003/0071730 A1
(43) Pub. Date: Apr. 17, 2003

(54) Traffic infringement electronic reporting system

(76) Inventor: Anil I. Valbh, Orlando, FL (US)

Correspondence Address: Michael I. Kroll, 171 Stillwell Lane, Syosset, NY, 11791, US

(21) Appl. No.: 09/977,739

(22) Filed: Oct. 15, 2001

(51) Int. Cl. G08B 13/14

(52) U.S. Cl. 340/572.1; 340/573.1; 235/435

(57) ABSTRACT

An information retrieval system for providing information concerning a driving and criminal record of a driver stopped for a traffic violation to a law enforcement officer. The system includes a card reading device for scanning data stored on a magnetic strip of a driver's license, a processor for analyzing the scanned data and a monitor for displaying the analyzed data. A transmitter wirelessly transmits the scanned data to a central station and a receiver receives an information signal from the central station concerning a person identified by the scanned driver's license. A printer is connected to the processor for printing a ticket concerning a violation committed. The received information signal is displayed on the monitor for viewing by the officer. The card reading device includes a first key for activating the transmitter to transmit the scanned data. The card reading device further comprises a transmit alert key for activating the transmitter to transmit the information signal to police vehicles within an area and an offense transmission key for transmitting a data signal indicative of a traffic offense committed, wherein the central station prints and mails a traffic ticket to the person identified in the driver's license.

### BACKGROUND OF THE INVENTION

1. Field of the Invention

The present invention relates generally to information retrieval systems and, more specifically, to a system for use by a law enforcement officer to obtain information regarding a motorist quickly and provide information to a central office regarding a traffic violation.

2. Description of the Prior Art

Numerous types of information retrieval systems have been provided in the prior art. FIG. 1 illustrates the conventional method for enforcing traffic violations. As can be seen from this figure, a law enforcement officer 10 has pulled over a driver 12 in a vehicle 14 for committing a traffic violation. Upon pulling the vehicle 14 over, the officer 10 approaches the vehicle 14 and obtains the driver's license of the driver 12. The officer 10 checks the driver's license and pulls out a violations ticket book 16. The officer 10 then obtains a pen 18 and begins filling in the relevant information on a ticket within the violations ticket book 16. The presently used method provides the officer 10 without any detailed information regarding the driver 12. This method also requires the officer 10 to fill out the ticket by hand thus increasing the amount of time required to perform the deed of enforcing traffic violations. The additional time required for a traffic stop decreases the amount of time an officer 10 is able to patrol an area. Additional examples of such prior art are found in U.S. Pat. Nos. 3,996,554; 4,982,072; 5,432,864; 5,948,038; 5,952,941; 6,089,452; 6,100,819; 6,102,285 and 6,121,898.

### U.S. Pat. No. 3,996,554

### Inventor: Andrew Peter Ives et al.

### Issued: Dec. 7, 1976

A data transmission system for a road vehicle has an aerial on the road vehicle for picking up signals from an external transmitter. This aerial passes a signal to a receiver on the vehicle which in turn passes the information to a memory unit which stores the information at a fast rate and then supplies the information at a slow rate to an electrical voice synthesizer.

### U.S. Pat. No. 4,982,072

### Inventor: Hiroshi Takigami

### Issued: Jan. 1, 1991

A driver's license being IC-carded, informations stored in the driver's license card is read out to detect matched or mismatched relations with a driver's license number set beforehand. The excess of penalty points of violation, uninsertion of the card, etc., and the permission and prohibition of starting an engine are decided on the basis of the result of the detection. Besides, the information stored in the driver's license card is made rewritable by using a keyboard and others provided in a driver's license card controller which is installed in a government office administrating driver's license, such as a police office, and thus the quick renewal and alteration of driver's are enabled.

### U.S. Pat. No. 5,432,864

### Inventor: Daozheng Lu et al.

### Issued: Jul. 11, 1995

The present invention provides apparatus and method for verifying the identity of a person by comparing that person's face (or selected facial features) with an image generated using data stored on an identification card, badge, tag or other escort memory carried by the person. Both automatic and manual verification apparatus are disclosed, and both employ principal component methods that reduce the amount of data required to be carried by the bearer to under 100 bytes. The process of verifying identity involves combining data from the small escort memory with other image-related data that are general in nature and that are stored at the verification location. The system of the present invention is expected to find use in a wide variety of cases where a person's identity is to be established (e.g. by a retail customer using a credit card, by a traffic officer who needs to verify the identity noted on a driver's license, by an industrial security system that regulates the access by selected personnel into a secure area of a plant or business, or by a customer of an automatic teller machine.)

### U.S. Pat. No. 5,948,038

### Inventor: James P. Daly et al.

### Issued: Sep. 7, 1999

A traffic violation processing method is disclosed, which includes the steps of monitoring a vehicle; determining whether the vehicle is in violation of a traffic violation and recording the image of the vehicle on a camera when the vehicle is determined to have violated a traffic violation; providing a digital image of the vehicle; recording and storing deployment data corresponding to the violation, wherein the deployment data includes an identifier associated with the traffic violation; assigning the identifier to the digital traffic image; storing the digital image of the vehicle, together with the identifier, on a storage medium; matching the deployment data with the stored digital image by correlating or matching the identifier associated with the deployment data with the identifier associated with the stored digital image; and generating a traffic document that includes the stored digital image and the deployment data.

### U.S. Pat. No. 5,952,941

### Inventor: Aris Mardirossian

### Issued: Sep. 14, 1999

A system and corresponding method for monitoring traffic violations. A satellite based system determines the location, and upon which roadway, a vehicle is traveling. A memory (e.g. RAM) in the vehicle system stores speed limit data relating to different roads, speed limits, and/or red lights across the globe. A controller in the vehicle compares, for example, speed limit data relative to determined speed of the vehicle so as to detect when the speed limit on the road upon which the vehicle is traveling is exceeded. When the speed limit is exceeded, a transmitter on the vehicle transmits a signal to at least one satellite indicative of the violation. The at least one satellite forwards the violation signal to a motor vehicle department so that a ticket can be issued to the vehicle operator. In a similar manner, the satellite based system can detect other infractions such as running of red lights, and issue tickets in response to same.

### U.S. Pat. No. 6,052,065

### Inventor: Deborah L. Glover

### Issued: Apr. 18, 2000

A new VIN Reading and Transmitting System for providing a device for automatically detecting a vehicle identification number and transmitting the number to a dispatch station for immediate identification of the vehicle and owner. The inventive device includes a vehicle unit containing the vehicle identification number, a portable unit which enables the vehicle unit to transmit the number which is detected by the portable unit, a digital repeator which receives a signal from the portable unit for transmitting to a receiver at the dispatch office where the number can be utilized to disclose the vehicle and the owner which can be transmitted to the police officer immediately.

### U.S. Pat. No. 6,089,452

### Inventor: Edward W. Rhode, III

### Issued: Jul. 8, 2000

An operator's license validation system for a motor vehicle which uses an operator's license which is encoded with data. The data encoded includes the expiration date of operating privileges. A card reader is provided which is designed to read the expiration data encoded on the card. The card reader transmits the information encoded on the license to a control unit. The control unit compares the expiration date to the contemporaneous data. If the expiration data has not expired, the control unit activates an indicator. If the expiration data has expired the control unit will not activate the indicator. The indicator is to be mounted a predetermined location that is visible to oncoming traffic.

### U.S. Pat. No. 6,100,819

### Inventor: Mark White

### Issued: Aug. 8, 2000

This invention relates to methods and apparatus for monitoring and regulating the flow of traffic through intersections and specifically to an improved method and apparatus for automatically detecting and documenting disregard of traffic signals for purposes of prosecuting offenders and reducing the risk posed to the driving public posed by disregard of traffic signals without the need for police presence. The present invention comprises traffic signalization lights at adjacent street intersections; a traffic detection and speed measurement means; a traffic light state sensor means; and a traffic light delay means designed to coordinate the traffic detection and speed measurement means and timing of the traffic signalization lights and a recording means to document the license plate number of violating vehicles. The system is designed to automatically detect and document disregard of traffic signals for purposes of creating evidence crucial for prosecuting traffic light violations and reducing the risk posed to innocent drivers by delaying the change to green of adjacent traffic signals when the system detects that a traffic signal has not been obeyed. A simple means for recording the date, time, and place of the violation can be easily incorporated as well.

### U.S. Pat. No. 6,102,285

### Inventor: Josef Elias

### Issued: Aug. 15, 2000

A parking metering system where the metering device is maintained within the vehicle for external inspection by a parking control person, the metering device in one embodiment having a display screen and light keys for visually displaying parking rate information by zone and remaining time, the metering device accounting for monies by use of a prepurchased debit card or account settlement by service centers, and in another embodiment the metering device includes a radio transmitter for short distance transmission of rate data and time data to a parking control officer equipped with a pager-like receiving device.

### U.S. Pat. No. 6,121,898

### Inventor: John B. Moetteli

### Issued: Sep. 19, 2000

A traffic law enforcement system having two or more enforcement units and at least one central computer connected via network devices. The enforcement units are spaced apart a given distance and each has a license plate reader. The central computer receives inputs from two not necessarily adjacent enforcement units, including identifying indicia, such as license plate numbers of passing vehicles. The enforcement units and the central computer cooperate to calculate an average velocity of a vehicle which passes between two not necessarily adjacent enforcement units by using the inputs of a) minimum-travel-time-drivable distance between enforcement units which transmitted matching identifying indicia, b) posted speed limit data between enforcement units which transmitted matching license plate numbers, and c) time lapsed between the transmission of the matching identifying indicia to the central computer. Optionally, after a predetermined amount of time, vehicle information which do not indicate violations, is erased.

While these units may be suitable for the particular purpose to which they address, they would not be as suitable for the purposes of the present invention as heretofore described.

It is thus desirable to provide an information retrieval system which is able to provide a law enforcement officer with instantaneous information concerning a motorist pulled over during a traffic stop. It is further desirable to provide an information retrieval system which is able to wirelessly transmit information read from a driver's license to a central data base for retrieving the driving record and criminal history of the driver. It is yet further desirable to provide an information retrieval system which is able to read data stored on a magnetic strip on a driver's license. It is even further desirable to provide an information retrieval system wherein a law enforcement officer is able to alert other officers as to the stopping of person considered dangerous. It is still further desirable to provide an information retrieval system which is able to generate a traffic ticket to be mailed to the stopped driver based upon data input by the law enforcement officer during the traffic stop.

### SUMMARY OF THE PRESENT INVENTION

The present invention relates generally to information retrieval systems and, more specifically, to a system for use by a law enforcement officer to obtain information regarding a motorist quickly and provide information to a central office regarding a traffic violation.

A primary object of the present invention is to provide an information retrieval system that will overcome the shortcomings of prior art devices.

Another object of the present invention is to provide an information retrieval system which is able to provide a law enforcement officer with instantaneous information concerning a motorist's driving record and criminal history during a traffic stop.

A further object of the present invention is to provide an information retrieval system which is able to wirelessly transmit information read from a driver's license to a central data base for retrieving the driving record and profile of the driver.

A yet further object of the present invention is to provide an information retrieval system which is able to read data stored on a magnetic strip on a driver's license.

A still further object of the present invention is to provide an information retrieval system wherein a law enforcement officer is able to alert other officers as to the stopping of person considered dangerous.

An even further object of the present invention is to provide an information retrieval system which is able to generate a traffic ticket to be mailed to the stopped driver based upon data input by the law enforcement officer during the traffic stop.

A yet further object of the present invention is to provide an information retrieval system that is simple and easy to use.

A still further object of the present invention is to provide an information retrieval system that is economical in cost to manufacture.

Additional objects of the present invention will appear as the description proceeds.

An information retrieval system for providing information concerning a driving and criminal record of a driver stopped for a traffic violation to a law enforcement officer is disclosed by the present invention. The system includes a card reading device for scanning data stored on a magnetic strip of a driver's license, a processor for analyzing the scanned data and a monitor for displaying the analyzed data. A transmitter wirelessly transmits the scanned data to a central station and a receiver receives an information signal from the central station concerning a person identified by the scanned driver's license. A printer is connected to the processor for printing a ticket concerning a violation committed. The received information signal is displayed on the monitor for viewing by the officer. The card reading device includes a first key for activating the transmitter to transmit the scanned data. The card reading device further comprises a transmit alert key for activating the transmitter to transmit the information signal to police vehicles within an area and an offense transmission key for transmitting a data signal indicative of a traffic offense committed, wherein the central station prints and mails a traffic ticket to the person identified in the driver's license.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWING FIGURES

Various other objects, features and attendant advantages of the present invention will become more fully appreciated as the same becomes better understood when considered in conjunction with the accompanying drawings, in which like reference characters designate the same or similar parts throughout the several views.

FIG. 1 is a perspective view of the law enforcement officer writing out a traffic ticket in the conventional manner;

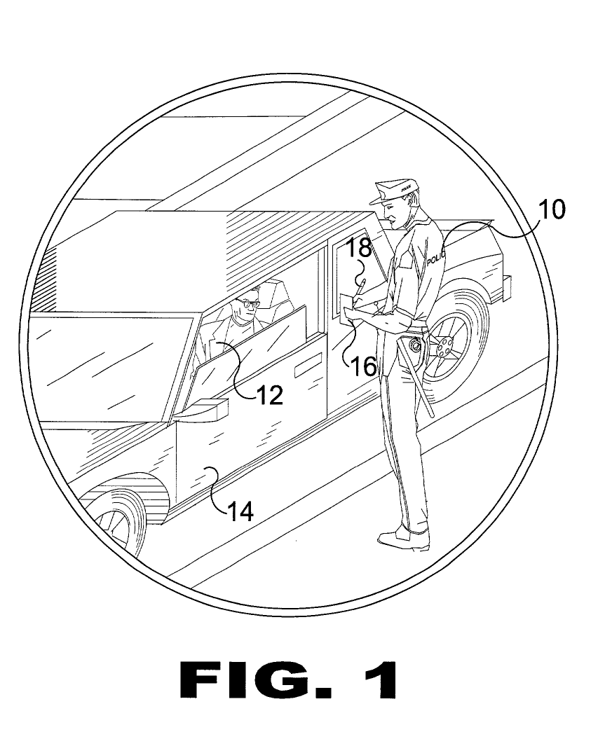

FIG. 2 is a perspective view of a law enforcement officer checking the police record of a person stopped for a traffic violation using the information retrieval system of the present invention;

FIG. 3 is a perspective view of the information retrieval system of the present invention;

FIG. 4 is a perspective view illustrating communication between the information retrieval system of the present invention and a central data base;

FIG. 5 is an enlarged view of the keyboard and display of the information retrieval system of the present invention; and

FIG. 6 is a block diagram of the information retrieval system of the present invention.

### DESCRIPTION OF THE REFERENCED NUMERALS

Turning now descriptively to the drawings, in which similar reference characters denote similar elements throughout the several views, the Figures illustrate the information retrieval system of the present invention. With regard to the reference numerals used, the following numbering is used throughout the various drawing figures.

| | |
|---|---|
| 10 | law enforcement officer |
| 12 | driver |
| 14 | vehicle of driver |
| 16 | violation ticket book |
| 18 | pen |
| 20 | information retrieval system of the present invention |
| 22 | police vehicle |
| 24 | driver's license |
| 26 | card reading device |
| 28 | display |
| 30 | keyboard |
| 31 | slot in card reading device |
| 32 | printer |
| 33 | cellular antenna for transmission and reception |
| 34 | cellular satellite receiver/transmitter |
| 36 | arrow indicating signal transmitted from information |
| | retrieval system |
| 38 | central data station |
| 40 | arrow indicating signal transmitted from satellite to |
| | central data station |
| 42 | arrow indicating signal transmitted from central data |
| | station to satellite |
| 44 | arrow indicating signal transmitted from satellite to |
| | system |
| 46 | keyboard keys |
| 47 | transmission control keys |
| 48 | enter key |
| 49 | wire connecting card reading device to processor |
| 50 | data transmission key |
| 51 | wire connecting printer to processor |
| 52 | alert transmission key |
| 54 | traffic offense transmission key |
| 56 | processor |
| 58 | power source |
| 60 | memory |
| 62 | cellular transmitter |
| 64 | cellular receiver |

### DETAILED DESCRIPTION OF THE PREFERRED EMBODIMENT

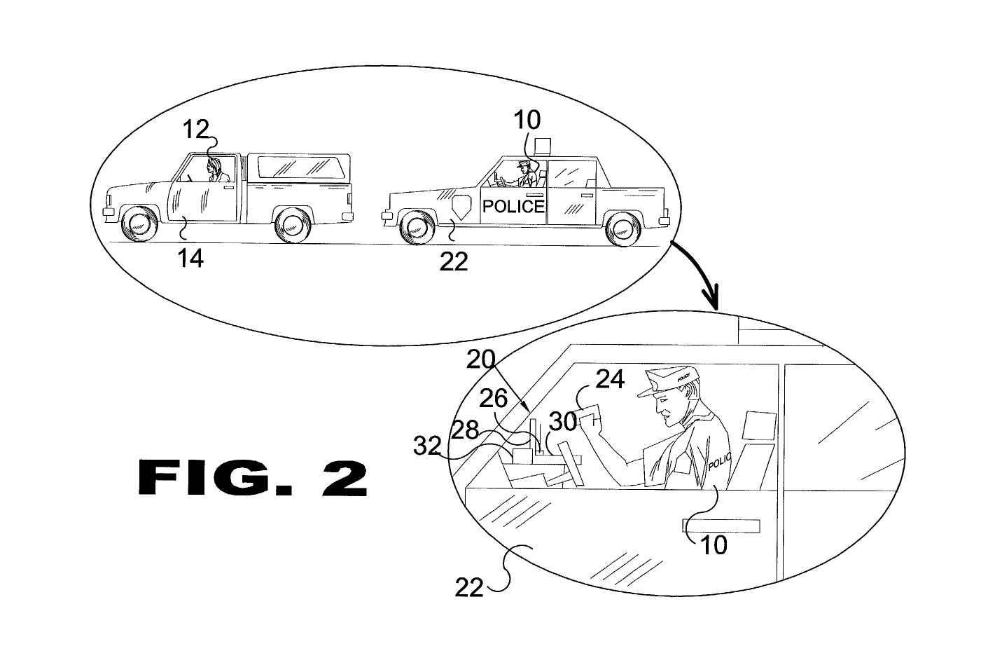

Turning now descriptively to the drawings, in which similar reference characters denote similar elements throughout the several views, FIGS. 2 through 6 illustrate the information retrieval system of the present invention indicated generally by the numeral 20.

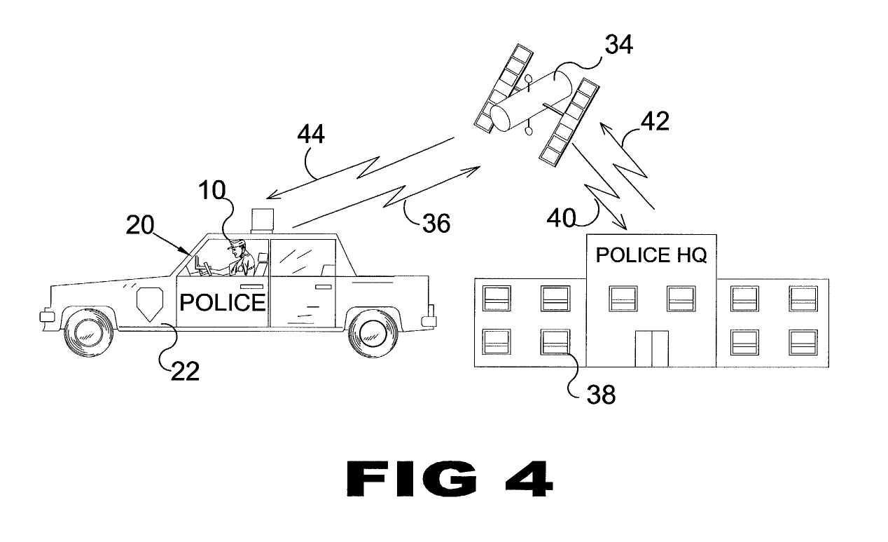

The information retrieval system 20 is illustrated in FIG. 2 positioned on a dashboard of a police vehicle 22. The law enforcement officer 10 has obtained a driver's license 24 from the driver 12 in the stopped vehicle 14 and has returned to the police vehicle 22. The information retrieval system 20 includes a card reading device 26, a keyboard 28, a monitor 30 and a printer 32. The information retrieval system is positioned within the police vehicle 22 such that the officer 10 is adjacent the information retrieval system 20 when seated in either the driver's or passenger's side seats within the police vehicle 22. Upon scanning the driver's license 24 by the card reading device 26 and entry of the appropriate information using the keyboard 28, a signal including the entered data is transmitted to a central station as illustrated in FIG. 4. The central station then analyzes the signal and transmits a response signal to the information retrieval system 20 for display on the monitor 30. Thus, the officer 10 is able to obtain all the desired information on both the driving and criminal records for the driver 12 of the stopped vehicle 14. The officer 10 is then able to determine if the driver 12 is dangerous and should be detained. As explained hereinafter, the officer 10 is able to alert other officers in the vicinity as to the stopping of a potentially dangerous person.

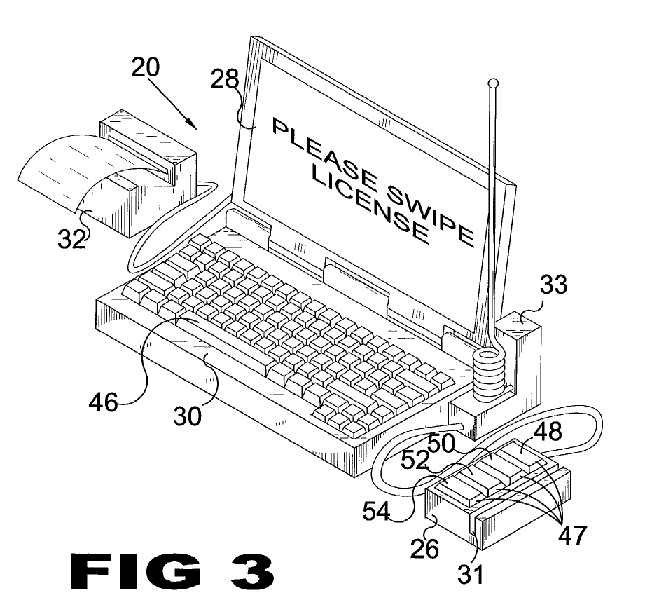

An enlarged view of the information retrieval system 20 is illustrated in FIG. 3. As can be seen from this figure, the information retrieval system 20 includes the card reading device 26, the keyboard/processor 28, the monitor 30 and the printer 32. A cellular antenna 33 is also connected to both the keyboard/processor 28 and the card reading device 26. The scanning device 32 includes a slot 31 through which the license 24 is passed. The scanning device 32 reads the data stored on a magnetic strip on the license 24 and provides the data to the keyboard/processor 30. Upon receipt of the data read by the card reading device 26, the keyboard/processor 30 provides instructions to the officer 10 on the display 28. The officer 10 responds to the instructions by inputting data using the keyboard 30. Upon completion of data entry, the officer 10 activates the information retrieval system 20 to transmit the data entered thereto to the central station. The data is transmitted to the central station upon activation of one of the transmission control keys 47 on the card reading device 26. Upon receipt of return data to the information retrieval system 20, the data received is displayed on the monitor 28. The officer 10 is then instructed to input any additional data such as the type of violation and is able to print a ticket using the printer 32. Alternatively, the officer 10 may transmit the information concerning the violation to the central station which processes the data and sends a ticket to the driver 12 via mail.

A view of the information retrieval system 20 transmitting data to and receiving data from the central data station 38 is illustrated in FIG. 4. As can be seen from this figure, the officer 10 enters the necessary data into the information retrieval system 20 within the police vehicle 22. This information is entered by reading a magnetic strip on a driver's license and input of any additional information via the keyboard upon requests from the processor. The information obtained by reading the magnetic strip may include any of the following but is not limited to the name, address, social security number, driver's license number and date of birth of the driver. Upon entry of the data, the officer activates the information retrieval system 20 to transmit a data signal via a wireless communications channel to a satellite 34. The transmission of the data signal is indicated by the arrow labeled with the numeral 36. The satellite 34 relays the data signal to a central station 38 such as a data center in the police station. The relay of the data signal is indicated by the arrow labeled with the numeral 40. The central station analyzes the received data signal and retrieves all stored information concerning the person identified by the information. This information is transmitted by the central station back to the satellite 34 in a return signal. The return signal is indicated by the arrow labeled with the numeral 42. The satellite 34 relays the return signal to the information retrieval system 20 within the police vehicle 22 for display on the monitor 28. The relay of the signal from the satellite to the information retrieval system 20 is indicated by the arrow labeled with the numeral 44.

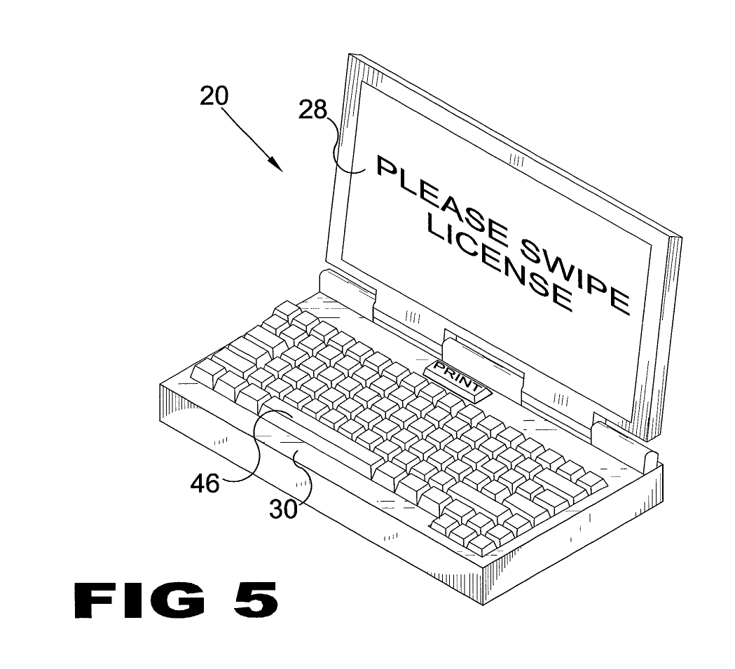

An enlarged view of the keyboard 30 and display 28 of the information retrieval system 20 is illustrated in FIG. 5. As can be seen from this figure, the keyboard 30 includes a plurality of data input keys 46 similar to a conventional keyboard. The keyboard further includes a print key (PRINT) for sending data to the printer 32 and printing of a ticket. Connected to the keyboard 30 is the display 28. The display 28 is provided for displaying requests to the user under the control of the keyboard/processor 30 and displaying information received from the central station 38. As can be seen from the display 28, the information retrieval system 20 is prepared to receive data by swiping of a driver's license. When an officer pulls over a vehicle and obtains the driver's license of the driver, the driver's license will be swiped through the card reader device 26 as can be seen from FIG. 3. Upon swiping of the driver's license, data stored on the magnetic strip thereon is transferred to the keyboard/processor 30. The keyboard/processor 30 will then display the data on the device, ask for additional data from the officer or transmit the data to the central station as illustrated in FIG. 4. Upon receipt of data from the central station, this data will be displayed on the display 28. Should additional data be required or the officer need to perform additional steps, instructions will be provided on the display.

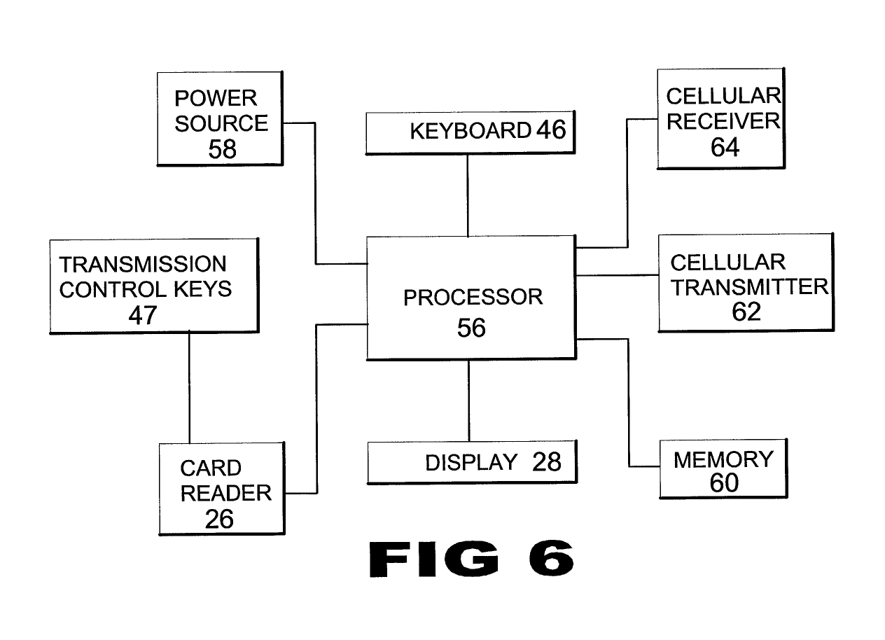

A block diagram of the information retrieval system 20 is illustrated in FIG. 6. As can be seen from this figure, the system for transferring information electronically 30 includes the processor 56. A power source 58 is connected to the processor 56 for providing the information retrieval system 20 with operating power. The power source 58 may be an external battery or the vehicle battery. A memory unit 60 is connected to the processor 56 for storing the programs necessary for operation of the processor 56 and also storing data read by the card reading device 26. The card reading device 26 is connected to the processor 34 for providing data read thereby for analysis. The transmission control keys 47 are connected to the processor 56 via the card reading device 26. The keyboard 46 is connected to input user entered data to the processor 56. A cellular transmitter 62 is connected to the processor 56 for transmitting data signals to the central station 38. The transmission control keys 47 activate the processor 56 to initiate transmission of a data signal to the central station 38 via the cellular transmitter 62. A cellular receiver 64 is provided for receiving wirelessly transmitted signals from the central station 38. The data signals received by the cellular transmitter 64 are provided to the processor 56 for analysis and display on the display 28.

The operation of the information retrieval system 20 will now be described with reference to the figures. In operation, the information retrieval system 20 is generally positioned on a dashboard of a police vehicle 22. The information retrieval system 20 is used to collect information concerning the driving and criminal records of a driver during a traffic stop. When a law enforcement officer 10 pulls a driver 12 over for committing a violation, the officer 10 asks the driver 12 for a driver's license 24. The officer 10 returns to the police vehicle 22 and inserts the driver's license 24 into the slot 31 of the card reading device 26. The driver's license 24 is then passed through the slot 31 and the data stored on the magnetic strip thereon is read by the card reading device 26. This data may include any of the following but is not limited to the name, address, social security number, driver's license number and date of birth of the driver. The card reading device 26 is preferably able to read a magnetic strip on driver's licenses from all states of the United States. The data read by the card reading device 26 is then provided to the processor 56 for analysis. The analyzed data is also stored in the memory unit 60. Should any additional data be needed or any required data not be read by the card reading device 26, the processor 56 generates a message for display on the monitor 28. In response to this message, the officer enters the pertinent information using the keyboard 46.

Once all the required data is input via the card reading device 26 and keyboard 46, the officer activates the data transmit key 50. Activation of this key 50 causes the processor 56 to activate the cellular transmitter 62 to transmit a data signal including the data read by the card reading device 26 and entered on the keyboard 46. The data signal is transmitted via a satellite 34 to a central station 38 including a data base therein. The central station analyzes the received data and transmits a return signal via the satellite back to the information retrieval system 20 including information concerning the driver's driving record and criminal record. The data signal is received by the antenna 33 and provided to the processor 56 for analysis. The processor then displays the analyzed data on the monitor 28 for review by the officer. Should the displayed data indicate that the driver is dangerous, e.g. has a criminal record or outstanding warrants, the office can activate the transmit alert key 52. Activation of the transmit alert key 52 generates a signal which is transmitted by the cellular transmitter 62 via the antenna 33 to alert other police vehicles 22 within the vicinity as to the situation. Should the officer 10 desire to have a ticket printed and mailed to the driver by the central station 38, information concerning the traffic violation is entered on the keyboard 46 and transmitted to the central station 38 by activating the offense transmit key 54. Activation of the offense transmit key 54 generates a signal including the relevant driver and vehicle information as well as information concerning the offense to the central station via the cellular transmitter 62 and the antenna 33.

If the officer 10 wishes to have a ticket printed in the vehicle 22 and given to the driver 12 at the present time, the officer inputs relevant driver and vehicle information as well as information concerning the offense using the keyboard 46. The officer 10 then activates the printer 32 to print the information on a ticket by entering a print command on the keyboard 46. The printer 32 then prints a ticket which the officer 10 presents to the driver 12.

From the above description it can be seen that the information retrieval system 20 of the present invention is able to overcome the shortcomings of prior art devices by providing a information retrieval system 20 which is able to provide a law enforcement officer with instantaneous information concerning a motorist's driving record and criminal history during a traffic stop upon wirelessly transmitting information read from a driver's license to a central data base. The information retrieval system is able to read data stored on a magnetic strip on a driver's license. The information retrieval system also allows a law enforcement officer to alert other officers as to the stopping of person considered dangerous and generate a traffic ticket to be mailed to the stopped driver based upon data input by the law enforcement officer during the traffic stop. Furthermore, the information retrieval system 20 of the present invention is simple and easy to use and economical in cost to manufacture.

It will be understood that each of the elements described above, or two or more together may also find a useful application in other types of methods differing from the type described above.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and desired to be protected by Letters Patent is set forth in the appended claims:

1. An information retrieval system, said system comprising:
a) a card reading device for scanning data stored on a magnetic strip of a driver's license;
b) a processor for analyzing the scanned data;
c) a monitor connected to said processor for displaying the analyzed data;
d) a transmitter for wirelessly transmitting the scanned data to a central station; and
e) a receiver for receiving an information signal concerning a person identified by the scanned driver's license, wherein said information signal is displayed on said monitor for viewing the information concerning the person identified by the scanned driver's license.

2. The system as recited in claim 1, wherein said information signal includes at least one of a driving record and a criminal record of the person identified by the scanned driver's license.

3. The system as recited in claim 2, wherein said card reading device includes a first key for activating said transmitter to transmit the scanned data to the central station.

4. The system as recited in claim 1, further comprising a printer for printing a ticket concerning a violation committed by the person identified by the scanned driver's license.

5. The system as recited in claim 1, wherein said system is positioned within a police vehicle.

6. The system as recited in claim 5, wherein said card reading device further comprises a transmit alert key for activating said transmitter to transmit said information signal to police vehicles within an area surrounding the police vehicle upon a determination that the person identified by the driver's license is dangerous.

7. The system as recited in claim 1, wherein said card reading device further comprises an offense transmission key for transmitting a data signal indicative of a traffic offense committed by the person identified in the driver's license to the central station, wherein the central station prints and mails a traffic ticket to the person identified in the driver's license.

8. The system as recited in claim 1, wherein said transmitter is a cellular transmitter.

9. The system as recited in claim 11, wherein said receiver is a cellular receiver.

10. The system as recited in claim 5, wherein said system is connected to receive operating power from a vehicle battery of the police vehicle.

11. An information retrieval system comprising:
a) a central station including:
i) a data storage system;
ii) a first receiver for receiving data signals;
iii) a first processor for retrieving data from said data storage system in response to receipt of a data signal by said first receiver; and
iv) a first transmitter for transmitting said retrieved data; and
b) an information system including:
i) a card reading device for scanning data stored on a magnetic strip of a driver's license;
ii) a second processor for analyzing the scanned data;
iii) a monitor connected to said processor for displaying the analyzed data;
iv) a second transmitter for wirelessly transmitting the scanned data to said central station; and
v) a second receiver for receiving said information signal from said central station concerning a person identified by the scanned driver's license, wherein said information signal is displayed on said monitor for viewing the information concerning the person identified by the scanned driver's license.

12. The system as recited in claim 11, wherein said information signal includes at least one of a driving record and a criminal record of the person identified by the scanned driver's license.

13. The system as recited in claim 12, wherein said card reading device includes a first key for activating said transmitter to transmit the scanned data to said central station.

14. The system as recited in claim 11, further comprising a printer for printing a ticket concerning a violation committed by the person identified by the scanned driver's license.

15. The system as recited in claim 11, wherein said system is positioned within a police vehicle.

16. The system as recited in claim 15, wherein said card reading device further comprises a transmit alert key for activating said transmitter to transmit said information signal to police vehicles within an area surrounding the police vehicle upon a determination that the person identified by the driver's license is dangerous.

17. The system as recited in claim 11, wherein said card reading device further comprises an offense transmission key for transmitting a data signal indicative of a traffic offense committed by the person identified in the driver's license to said central station, wherein said central station further includes a printer for printing a traffic ticket to be mailed to the person identified in the driver's license.

18. The system as recited in claim 11, wherein said transmitter is a cellular transmitter.

19. The system as recited in claim 11, wherein said receiver is a cellular receiver.

20. The system as recited in claim 15, wherein said system is connected to receive operating power from a vehicle battery of the police vehicle.
